(19) United States
(12) Patent Application Publication
(10) Pub. No.: US 2010/0131228 A1
(43) Pub. Date: May 27, 2010

(54) MOTION MODE DETERMINATION METHOD AND APPARATUS AND STORAGE MEDIA USING THE SAME

(76) Inventors: Mao-Chi HUANG, Dacun Township (TW); Chi-Hung Tsai, Taichung City (TW); Augustine Tsai, Taipei City (TW)

Correspondence Address: BIRCH STEWART KOLASCH & BIRCH, PO BOX 747, FALLS CHURCH, VA, 22040-0747, US

(21) Appl. No.: 12/466,654

(22) Filed: May 15, 2009

(30) Foreign Application Priority Data
Nov. 27, 2008 (TW) 97145898

(51) Int. Cl. G06F 15/00; G01P 15/00

(52) U.S. Cl. 702/141; 702/189

(57) ABSTRACT

A motion mode determination apparatus is disclosed, including an inertial device, a frequency decomposition module, a characteristic value generator, a training module and a determination module. The inertial device collects at least a first motion signal corresponding to a first motion mode and at least a second motion signal corresponding to a second motion mode, wherein each of the first and second motion signals includes a first signal, a second signal and a third signal. The frequency decomposition module decomposes the first signal into a first high-frequency signal and a first low-frequency signal. The characteristic value generator generates a plurality of characteristic values, wherein the characteristic values are the means and variances for each group of the first high-frequency signals, the first low-frequency signals, the second signals and the third signals respectively. The training module generates first and second data groups. The determination module determines the motion mode of a third motion signal.

This Application claims priority of Taiwan Patent Application No. 97145898, filed on Nov. 27, 2008, the entirety of which is incorporated by reference herein.

### BACKGROUND OF THE INVENTION

1. Field of the Invention

The invention relates generally to a motion mode determination method and apparatus and storage media using the same, and more particularly, to a motion mode determination method and apparatus and storage media using the same, which is capable of determining the surrounding terrain of a pedestrian.

2. Description of the Related Art

Electronic devices have become an essential part of every day life for humans. For example, when traveling, a Global Positioning System (GPS) is used to find the most appropriate routes for traveling. However, the GPS is not suitable for indoor usage, and even more is not suitable for a pedestrian. So it is necessary to provide a pedestrian with a motion mode determination method and apparatus for judging the surrounding terrain and helping him by the auxiliary guidance service.

### BRIEF SUMMARY OF THE INVENTION

The invention discloses a motion mode determination apparatus. The motion mode determination apparatus comprises an inertial device, a frequency decomposition module, a characteristic value generator, a training module and a determination module. The inertial device collects at least a first motion signal corresponding to a first motion mode and at least a second motion signal corresponding to a second motion mode, wherein each of the first motion signal and the second motion signal comprises a first signal, a second signal and a third signal. The frequency decomposition module decomposes each of the first signals into a first high-frequency signal and a first low-frequency signal. The characteristic value generator generates a plurality of characteristic values, wherein the characteristic values are the means and variances for each group of the first high-frequency signals, the first low-frequency signals, the second signals and the third signals respectively. The training module generates a first data group corresponding to the first motion mode and a second data group corresponding to the second motion mode, according to the characteristic values. The determination module determines the motion mode of a third motion signal according to the generated first data group and the second data group.

Furthermore, the invention discloses a motion mode determination method. The method comprises collecting at least a first motion signal corresponding to a first motion mode and at least a second motion signal corresponding to a second motion mode, wherein each of the first motion signal and the second motion signal comprises a first signal, a second signal and a third signal. The method further comprises decomposing each of the first signals into a first high-frequency signal and a first low-frequency signal. The method further comprises generating a plurality of characteristic values, wherein the characteristic values are the means and variances for each group of the first high-frequency signals, the first low-frequency signals, the second signals and the third signals respectively. The method further comprises generating a first data group corresponding to the first motion mode and a second data group corresponding to the second motion mode, according to the characteristic values. The method further comprises determining the motion mode of a third motion signal according to the generated first data group and the second data group.

Furthermore, the invention discloses a storage medium for storing a motion mode determination program. The motion mode determination program comprises a plurality of program codes to be loaded onto a computer system so that a motion mode determination method may be executed by the computer system. The method comprises collecting at least a first motion signal corresponding to a first motion mode and at least a second motion signal corresponding to a second motion mode, wherein each of the first motion signal and the second motion signal comprises a first signal, a second signal and a third signal. The method further comprises decomposing each of the first signals into a first high-frequency signal and a first low-frequency signal. The method further comprises generating a plurality of characteristic values, wherein the characteristic values are the means and variances for each group of the first high-frequency signals, the first low-frequency signals, the second signals and the third signals respectively. The method further comprises generating a first data group corresponding to the first motion mode and a second data group corresponding to the second motion mode, according to the characteristic values. The method further comprises determining the motion mode of a third motion signal according to the generated first data group and the second data group.

### BRIEF DESCRIPTION OF THE DRAWINGS

For fully understanding the of the purpose, the features, and the advantage of the invention, preferred embodiments of the invention are illustrated in the accompanying drawings and described in detail with reference to the following description. In the drawings:

FIG. 1 shows a block diagram of the pedestrian motion mode determination apparatus according to an embodiment of the invention;

FIG. 2 shows an flowchart of the pedestrian motion mode determination method according to an embodiment of the invention;

FIG. 3A shows an exemplary diagram for the first signal according to an embodiment of the invention;

FIG. 3B shows a diagram of frequency decomposition for signal samples divided from accelerator signals, according to an embodiment of the invention; and

FIG. 4 shows a diagram of a training result according to an embodiment of the invention.

### DETAILED DESCRIPTION OF THE INVENTION

The following description is the preferred embodiment for carrying out the invention. This description is made for the purpose of illustrating the general principles of the invention and should not be taken in a limiting sense. The scope of the invention is best determined by reference to the appended claims.

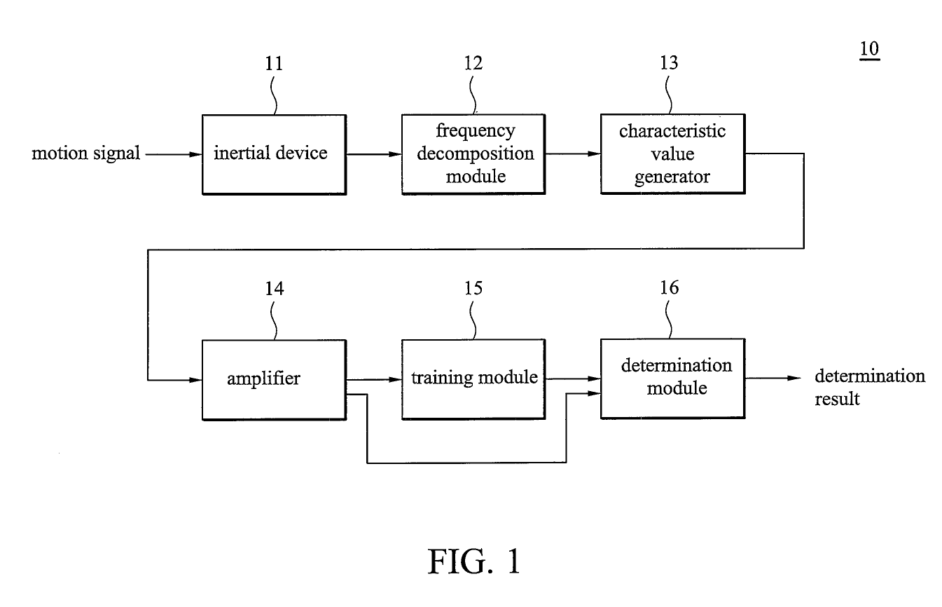

FIG. 1 depicts a block diagram of a pedestrian motion mode determination apparatus 10 according to an embodiment of the invention. The pedestrian motion mode determination apparatus 10 comprises an inertial device 11, a frequency decomposition module 12, a characteristic value generator 13, an amplifier 14, a training module 15 and a determination module 16. The details will be illustrated below.

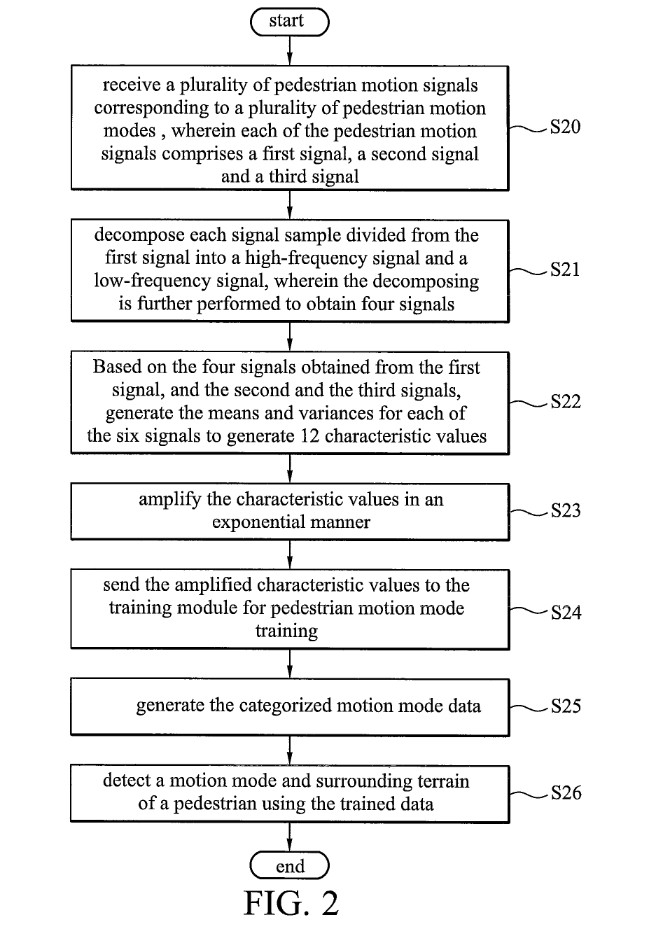

FIG. 2 depicts a flowchart of the pedestrian motion mode determination method according to an embodiment of the invention. When beginning operation, the pedestrian motion mode determination apparatus 10 collects various motion signals corresponding to various motion modes. The motion signals for the motion modes are trained and categorized. Then the signals after trained and categorized can be used to determine the surrounding terrain of a user and helping him by the auxiliary guidance service.

In the embodiment, the invention assumes that the inertial device 11 initially receives a pedestrian motion signal “walking” corresponding to a pedestrian motion mode “walking”, as well as another pedestrian motion signal “walking upstairs” corresponding to the pedestrian motion mode “walking upstairs” (step S20). In some embodiments, the inertial device 11 comprises an accelerator, a gyro and a compass. Each of the pedestrian motion signals comprises a first signal collected by the accelerator, a second signal collected by the gyro, and a third signal collected by the compass.

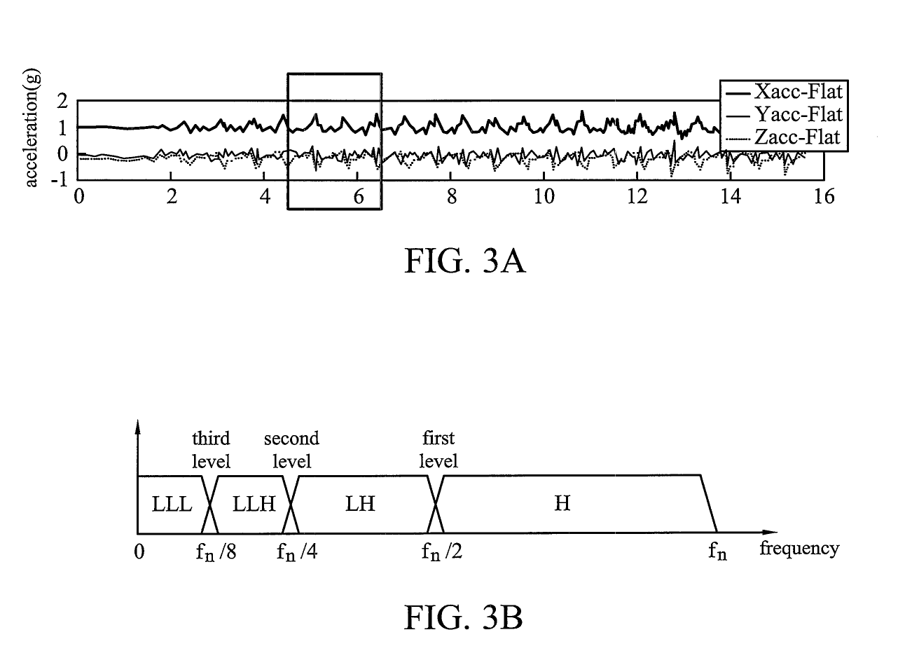

After the pedestrian motion signals “walking” and “walking upstairs” are collected, the next step is to extract a plurality of characteristic values from the collected signals, such as the first signals, second signals and third signals collected by the accelerator, the gyro and the compass. For the collected first signals by the accelerator, the characteristic values are obtained by frequency decomposition. Referring to FIG. 3A which shows an exemplary diagram for the first signal, the frequency decomposition module 12 divides the first signal into a plurality of signal samples, wherein each sample has a time length of 2 seconds and the interval time of 0.5 seconds (one signal sample extracted/per 0.5 seconds) for example. Thus, numerous continuous signal samples are extracted from the first signal. The purpose of signal dividing is to reflect a continuous pedestrian motion mode. If the first signal is not divided into signal samples, the data analysis would not be accurate since there could be several motion modes contained in the first signal.

Next, the frequency decomposition module 12 decomposes each signal sample into a high-frequency signal and a low-frequency signal using wavelet transform (step S21), as shown in FIG. 3B. Referring to FIG. 3B, the frequency decomposition module 12 firstly decomposes each signal sample into a first level high-frequency signal (H) and a first level low-frequency signal (L). Next, the frequency decomposition module 12 decomposes each first level low-frequency signal (L) into a second level high-frequency signal (LH) and a second level low-frequency signal (LL). Following, the frequency decomposition module 12 decomposes each second level low-frequency signal (LL) into a third level high-frequency signal (LLH) and a third level low-frequency signal (LLL). In this embodiment, the frequency decomposition procedure is performed for three levels, however, more levels may perform the frequency decomposition procedure as desired. Next, the four signals: the first level high-frequency signal (H), the second level high-frequency signal (LH), the third level high-frequency signal (LLH) and the third level low-frequency signal (LLL), are used as the representative signals for the first signal.

Based on the four representative signals, the second and the third signals for each motion signal, the characteristic value generator 13 generates the means and variances for each group of the six signals (step S22) respectively, so that 12 characteristic values are obtained. In some embodiments, the 12 characteristic values are not yet appropriate for signal analysis since they are somewhat weak in signal strength. Thus, the amplifier 14 is provided to amplify the characteristic values in an exponential manner (step S23). The amplified characteristic values are later sent to the training module 15 for pedestrian motion mode training (step S24). A Support Vector Machine (SVM) algorithm is provided by the training module 15 for training of the pedestrian motion mode.

In some embodiments, the following formula is provided for data training by the training module 15:

$$d ( x ) = {\sum }_{xi ∈ SVs} {α}_{i} {y}_{i} K ( {x}_{i} , x ) + b , \qquad ( A )$$

wherein, X is characteristic value vector for unanalyzed data, αᵢ and b are constants which are generated during the training of the SVM algorithm, K is a Kernel Function, which is used to project data from a current dimension to a higher dimension, xᵢ is a support vector, which is generated during the training of SVM algorithm, and yᵢ is the corresponding label with respect to xᵢ, such as a level group or a stairway.

Next, after all characteristic values are trained by the SVM algorithm, categorized motion mode data are generated (step S25). Following, the categorized motion mode data is stored in a pedestrian navigator, such that a motion mode and surrounding terrain of a pedestrian can be detected using the trained data (step S26), thus further providing auxiliary guidance services.

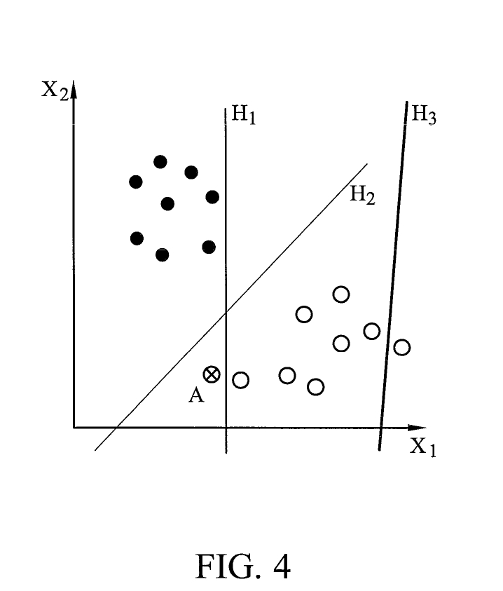

FIG. 4 shows a diagram of a training result according to an embodiment of the invention. For example in FIG. 4, the training dimension is 2 (2D), and the training result shown in FIG. 4 is generated by the SVM algorithm training the extracted characteristic values. In FIG. 4, each white or black dot represents a signal sample. Note that the signal samples distribution for the same motion mode appears congregated. As an example, the data group of black dots may represent the motion mode “walking”, whereas the data group of white dots may represent the motion mode “walking upstairs”. As a result, the black dots represent a category of motion mode “walking”, and the white dots represent another category of motion mode “walking-upstairs”.

Following, how the trained data is used to determine an on-going motion mode of a pedestrian is described.

When a pedestrian is moving (walking, running, etc.), the pedestrian motion mode determination apparatus 10 receives a motion signal through the inertial device 11. Then, the characteristic value generator 13 generates characteristic values thereof. The amplifier 14 next amplifies the characteristic values, and the determination module 16, according to the amplified characteristic values, determines which data group is located closest to the signal sample of the motion signal. If the signal sample of the motion signal is located closer to the black dots group, then the pedestrian motion mode determination apparatus 10 is determined to be under the motion mode “walking”. Therefore, it is determined that the surrounding terrain is a level group. On the contrary, if the signal sample of the motion signal is located closer to the white dots group, then the pedestrian motion mode determination apparatus 10 is determined to be under the motion mode “walking-upstairs”. Therefore, it is determined that the surrounding terrain of the pedestrian is a stairway.

A separate line determined by the previously described Formula (A) can be used to determine which data group the pedestrian motion mode is close to. As shown in FIG. 4, the training module 15 is required to generate a line which can separate the black and white dot groups, with substantially the same distance to each data group, and line H1, H2, and H3 are drawn for illustration. Referring to the line H1 in FIG. 4, even though it lies between the black and white data groups, it is not considered a qualified line since not every portion of the line is substantially the same distance to each data group. Note that using a non-qualified line for determining a motion mode will lead to an erroneous analysis. As an example, assume a signal sample of a current pedestrian motion signal located on point A, as shown in FIG. 4, is considered as the same motion mode represented by the white dots data group since the signal sample is located closer to the white dots data group. However, according to the line H1, the signal sample should be instead categorized as the same motion mode represented by the black dots data group since the signal sample is located on the same side with the black dots data group. Additionally, the line H3 seems non-qualified since it does not separate the black and white data group. Thus, the most qualified line is H2, since every portion of the line is substantially the same distance to each data group. Therefore, the line H2 is the best solution for determining an unknown motion mode of a pedestrian.

Note that in FIG. 4, the exemplary data dimension is 2. However, more than 2 data dimensions may be applied. In addition, the trained motion modes are not limited to “walking” and “walking upstairs”.

Finally, the pedestrian motion mode determination method can be recorded as a program in a storage medium for performing the above procedures, such as an optical disk, floppy disk and portable hard drive and so on. It is to be emphasized that the program of the pedestrian motion mode determination method is formed by a plurality of program codes corresponding to the procedures described above.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion mode determination apparatus for a pedestrian, comprising:
an inertial device collecting at least a first motion signal corresponding to a first motion mode and at least a second motion signal corresponding to a second motion mode, wherein each of the first motion signal and the second motion signal comprises a first signal, a second signal and a third signal;
a frequency decomposition module decomposing each of the first signals into a first high-frequency signal and a first low-frequency signal;
a characteristic value generator generating a plurality of characteristic values, wherein the characteristic values are the means and variances for each group of the first high-frequency signals, the first low-frequency signals, the second signals and the third signals respectively;
a training module generating a first data group corresponding to the first motion mode and a second data group corresponding to the second motion mode, according to the characteristic values; and
a determination module determining the motion mode of a third motion signal according to the generated first data group and the second data group.

2. The motion mode determination apparatus for a pedestrian as claimed in claim 1, wherein the inertial device comprises:
an accelerator for collecting the first signal;
a gyro for collecting the second signal; and
a compass for collecting the third signal.

3. The motion mode determination apparatus for a pedestrian as claimed in claim 1, wherein the first high-frequency signal and the first low-frequency signal are decomposed from the first signal utilizing wavelet transform.

4. The motion mode determination apparatus for a pedestrian as claimed in claim 1, further comprising an amplifier amplifying the characteristic values, wherein the training module generates the first data group and the second data group according to the amplified characteristic values.

5. The motion mode determination apparatus for a pedestrian as claimed in claim 1, wherein the frequency decomposition module further decomposes each of the first low-frequency signals into a second high-frequency signal and a second low-frequency signal, and the characteristic values are the means and variances for each group of the first high-frequency signals, the second high-frequency signals, the second low-frequency signals, the second signals and the third signals respectively.

6. The motion mode determination apparatus for a pedestrian as claimed in claim 5, wherein the frequency decomposition module further decomposes each of the second low-frequency signals into a third high-frequency signal and a third low-frequency signal, and the characteristic values are the means and variances for each group of the first high-frequency signals, the second high-frequency signals, the third high-frequency signals, the third low-frequency signals, the second signals and the third signals respectively.

7. A motion mode determination method for a pedestrian, comprising:
collecting at least a first motion signal corresponding to a first motion mode and at least a second motion signal corresponding to a second motion mode, wherein each of the first motion signal and the second motion signal comprises a first signal, a second signal and a third signal;
decomposing each of the first signals into a first high-frequency signal and a first low-frequency signal;
generating a plurality of characteristic values, wherein the characteristic values are the means and variances for each group of the first high-frequency signals, the first low-frequency signals, the second signals and the third signals respectively;
generating a first data group corresponding to the first motion mode and a second data group corresponding to the second motion mode, according to the characteristic values; and
determining the motion mode of a third motion signal according to the generated first data group and the second data group.

8. The motion mode determination method for a pedestrian as claimed in claim 7, further comprising utilizing wavelet transform to decompose each of the first signals into the first high-frequency signal and the first low-frequency signal.

9. The motion mode determination method for a pedestrian as claimed in claim 7, further comprising:
amplifying the characteristic values; and
generating the first data group and the second data group according to the amplified characteristic values.

10. The motion mode determination method for a pedestrian as claimed in claim 7, further comprising decomposing each of the first low-frequency signals into a second high-frequency signal and a second low-frequency signal, and the characteristic values are the means and variances for each group of the first high-frequency signals, the second high-frequency signals, the second low-frequency signals, the second signals and the third signals.

11. The motion mode determination method for a pedestrian as claimed in claim 10, further comprising decomposing each of the second low-frequency signals into a third high-frequency signal and a third low-frequency signal, and the characteristic values are the means and variances for each group of the first high-frequency signals, the second high-frequency signals, the third high-frequency signals, the third low-frequency signals, the second signals and the third signals respectively.

12. A storage medium for storing a motion mode determination program, wherein the motion mode determination program comprises a plurality of program codes to be loaded onto a computer system so that a motion mode determination method for a pedestrian is executed by the computer system, and the motion mode determination method comprises:
collecting at least a first motion signal corresponding to a first motion mode and at least a second motion signal corresponding to a second motion mode, wherein each of the first motion signal and the second motion signal comprises a first signal, a second signal and a third signal;
decomposing each of the first signals into a first high-frequency signal and a first low-frequency signal;
generating a plurality of characteristic values, wherein the characteristic values are the means and variances for each group of the first high-frequency signals, the first low-frequency signals, the second signals and the third signals respectively;
generating a first data group corresponding to the first motion mode and a second data group corresponding to the second motion mode, according to the characteristic values; and
determining the motion mode of a third motion signal according to the generated first data group and the second data group.

13. The storage medium as claimed in claim 12, wherein the pedestrian motion mode determination method further comprises utilizing wavelet transform to decompose each of the first signals into the first high-frequency signal and the first low-frequency signal.

14. The storage medium as claimed in claim 12, wherein the pedestrian motion mode determination method further comprises:
amplifying the characteristic values; and
generating the first data group and the second data group according to the amplified characteristic values.

15. The storage medium as claimed in claim 12, wherein the pedestrian motion mode determination method further comprises decomposing each of the first low-frequency signals into a second high-frequency signal and a second low-frequency signal, and the characteristic values are the means and variances for each group of the first high-frequency signals, the second high-frequency signals, the second low-frequency signals, the second signals and the third signals respectively.

16. The storage medium as claimed in claim 15, wherein the pedestrian motion mode determination method further comprises decomposing each of the second low-frequency signals into a third high-frequency signal and a third low-frequency signal, and the characteristic values are the means and variances for each group of the first high-frequency signals, the second high-frequency signals, the third high-frequency signals, the third low-frequency signals, the second signals and the third signals respectively.
